(19) United States
(12) Patent Application Publication
(10) Pub. No.: US 2008/0120189 A1
(43) Pub. Date: May 22, 2008

(54) METHOD AND APPARATUS FOR PROVIDING WORKFLOW AUTOMATION

(75) Inventors: Sumit Singh, Irving, TX (US); Katherine Ricker Brown, Colleyville, TX (US); Sanjiv Shah, Irving, TX (US); Javier Martinez, Coppell, TX (US); Venkateswara Nagarapu, Irving, TX (US); Leena Naidu, Irving, TX (US)

Correspondence Address: VERIZON;PATENT MANAGEMENT GROUP, 1515 N. COURTHOUSE ROAD, SUITE 500, ARLINGTON, VA, 22201-2909, US

(73) Assignee: MCI, LLC., Basking Ridge, NJ (US)

(21) Appl. No.: 11/553,888

(22) Filed: Oct. 27, 2006

(51) Int. Cl. G06Q 20/00

(52) U.S. Cl. 705/16; 705/26

(57) ABSTRACT

An approach is provided for automating workflow. A sales order is received. One of a plurality of implementation centers is selected based on a rule. The sales order is stored in one of a plurality of queues that are mapped to the implementation centers.

### BACKGROUND INFORMATION

Business organizations rely on accurate and efficient sales processes to ensure profitability. Unfortunately, organizations, in particular large companies, are susceptible to inefficiencies in their processes because of the volume of orders and the number of employees involved. These sales orders should then be passed off to an appropriate department or implementation center for carrying out the service or delivery the product specified in the orders. The complexity of handling such sales orders can increase rapidly if the organization employ multiple, geographically dispersed sales centers and implementation centers, across a wide range of products and services. Also, new or untrained sales representatives can reduce the efficiency of order processing. As a further challenge, many of the processes lack automation and integration. Not surprisingly, misdirected sales orders are common, resulting in significant revenue loss.

Therefore, there is a need for an automated workflow process for accurately and efficiently directing orders.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of an automated sales order fulfillment system capable of accurately routing sales orders, in accordance with an exemplary embodiment;

FIG. 2 is a diagram of a workflow router that includes a rules engine to route sales orders, according to an exemplary embodiment;

FIG. 3 is a flowchart of an automated order process utilizing rules for routing sales orders, according to an exemplary embodiment;

FIG. 4 is a diagram of routing rules database, according to an exemplary embodiment;

FIGS. 5A and 5B are flowcharts of processes of specifying the rules for selection of an implementation center and an order handler, respectively, according to various exemplary embodiments;

FIG. 6 is a diagram of an exemplary graphical user interface (GUI) for specifying rules for selection of an implementation center, according to an exemplary embodiment

FIG. 7 is a diagram of an exemplary graphical user interface for displaying and updating rules for selection of an implementation center, according to an exemplary embodiment;

FIG. 8 is a diagram of an exemplary graphical user interface for an agent to specify rules for agent selection, according to an exemplary embodiment;

FIG. 9 is a diagram of an exemplary graphical user interface for a user to specify or updating rules for selection of an agent, according to an exemplary embodiment; and

FIG. 10 is a diagram of a computer system that can be used to implement various exemplary embodiments.

### DETAILED DESCRIPTION

An apparatus, method, and software for automatically routing orders using rules/criteria-based based logic are described. In the following description, for the purposes of explanation, numerous specific details are set forth in order to provide a thorough understanding of the various exemplary embodiments. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

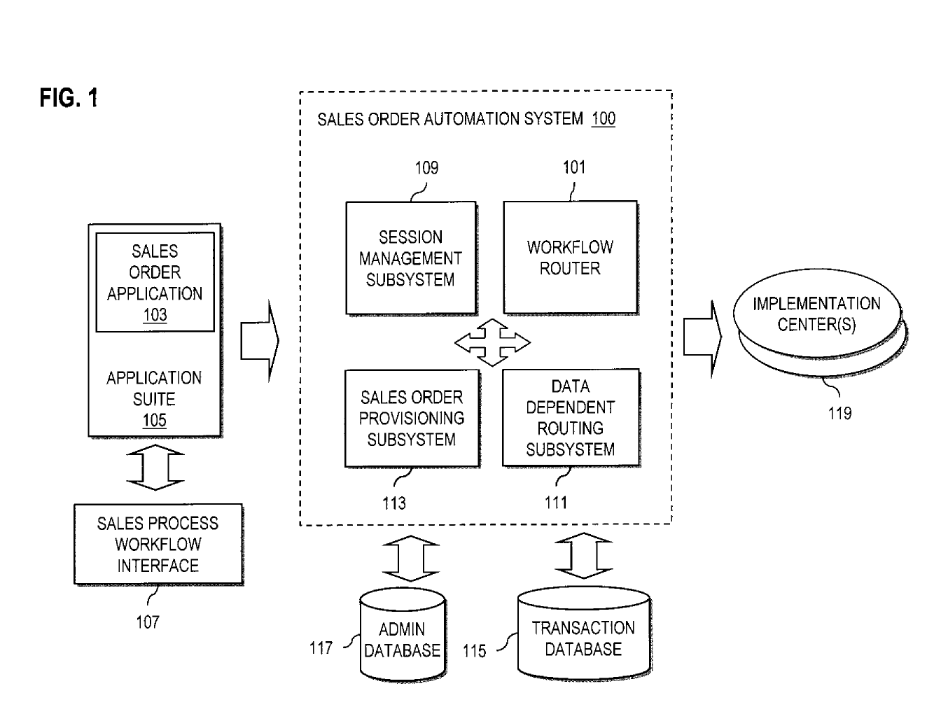

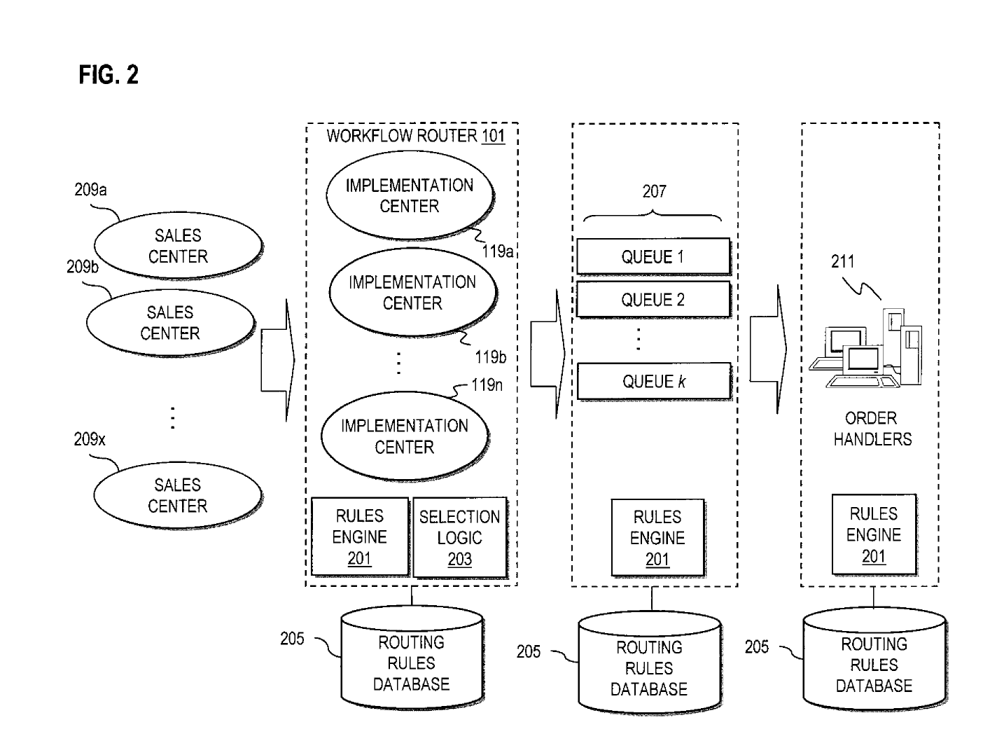

FIG. 1 is a diagram of an automated sales order fulfillment system capable of accurately routing sales orders, in according with an exemplary embodiment. An automated sales force workflow system 100 encompasses a workflow router 101 for distributing sales orders generated from a sales order application 103. The sales order application 103 can be part of an application suite 105 that supports sales and marketing functions, which lead to the fulfillment of sales orders. The application suite 105 can be deployed in multiple sales centers (as depicted in FIG. 2). A user can interact with the application suite 105 using a sales process workflow interface 107 as a front end presentation screen to utilize any number of sales, marketing, and even accounting applications. At any point in any application, user-entered data related to a sales order may be collected.

The system 100 may include a session management subsystem 109 to maintain copies of collected data for persistence across applications, to eliminate, for instance, the need for user re-keying of information, thereby more efficiently conducting transactions. The session management subsystem 109 can pre-populate an interface screen with any previously-collected data related to the sales order. Upon completion of the sales order, the session management subsystem 109 can initiate the order implementation process by forwarding the collected sales order data to data dependent routing subsystem 111.

Among other functions, the data dependent routing subsystem 111 may be used to load balance the transfer of data to the system 100. The subsystem 111 communicates via a sales order provisioning system 113 to deposit the collected data in a transaction database 115.

An administration database (denoted as “admin database”) 117 is also maintained to store user profile information and other management information about the system 100. In an exemplary embodiment, the admin database 117 can store business rules and criteria necessary of the workflow router 101 to process the sales orders.

As shown, the workflow router 101 communicates with one or more implementation centers 119 to properly route the sales orders based on the business rules. As such, these implementation centers 119 represent multiple end points for completed order handling. Accordingly, the workflow router 101 performs selection decisions as to avoid mistaken identification of available, capable end points and/or lost parts of a multi-item order.

The system 100 is in contrast to traditional approaches, whereby the selection decision-making control is assigned to the sales order creator. This approach requires a manual, cumbersome set of decisions that can jeopardize the proper processing of the order. Typically, the order creator manually selects the particular order implementation center that is to service the order. In a large organization, the number of implementation centers can number in the hundreds. With complex orders (having many components and involving many business products and departments), the proper selection may depend on a number of factors that are beyond the knowledge of the order creator. Even with extensive initial training, the order creator is prone to make mistakes, in that the organizational changes as well as new products and services are likely to impact the decision making process. For example, products and services in some industries are available under different conditions in different states, different regions, or different countries. Any order creator whose territory covers multiple locations may simply choose the wrong implementation center by mistaking the customer's location. Moreover, because the selection process is manually handled by a human agent, there is potential for selection error.

As will be further described, the workflow router 101 is invoked to perform routing decisions for incoming sales orders. This approach eliminates the manual steps in selecting implementation centers. Also, the workflow router 101, in one embodiment, can improve sales work force utilization by automating the decision-making process using routing rules that can be formulated based on domain knowledge possessed by experts. The architecture of the workflow router 101, in an exemplary embodiment, is illustrated in FIG. 2.

FIG. 2 is a diagram of a workflow router that includes a rules engine to route sales orders, according to an exemplary embodiment. The workflow router 101 includes a rules engine 201 that operates in conjunction with a selection logic 203 for applying routing rules from a rules database 205 to forward the sales orders to the proper endpoints. The diagram provides a flow diagram of the points where rules are applied to make selection decisions. In this example, the selection logic 203 assigns a sales order to a queue 207 according to the rules. As an order is received by the workflow router 101, the rules engine 201 is invoked to determine the implementation center 119 and queues 207 where the order should be assigned. After the determination, the order is placed in that queue 207 in a real time synchronous fashion. In an exemplary embodiment, the rules are table driven, and thus, are highly configurable.

The queues 207 are mapped to one or more of the implementation centers 119, depending on the rules. Furthermore, the queues 207 can be assigned to an agent or order handler 211. Further, according to an exemplary embodiment, the implementation centers 119 are sub-divided into the queues 207 with a configurable number of order handlers assigned to specific queues. Also, the queues 207 can be classified based on the products and services of the sales orders; that is, sales orders for a particular product can be mapped to an implementation center 119 that specializes on handling such products.

As shown, sales orders can originate from a multitude of sales centers 209, and are routed based on the rules. According to an exemplary embodiment, the rules can be organized as follows: (1) rules that direct the sales orders to an implementation center 119, and (2) rules that route the sales orders to an agent or order handler within the selected implementation center 119. The first set of rules can be defined based on, for example, priority of the sale order, region (geographic location) where the sales order should be fulfilled, the activity associated with the sales order (e.g., new customer installation, add new line, disconnect service, etc.), the products or services specified in the sales order (e.g., calling plan, data, voice, online, video, long distance and Customer Premise Equipments (CPE), etc.), sales center (e.g., location, or other attributes of the sales center), implementation center and queue, and/or Carrier Services Gateway (CSG) code.

The second set of rules is utilized by the selection logic 203 to route the order from the queue 207 to an individual order handler (or implementation representative) by examining through various combinations of criteria. These criteria, for example, can include determining which queues 207 are under the responsibility of the agent, product proficiency of the agent, the agent's current workload, the types of tariffs that the agent handles, working hours, and maximum workload (e.g., affordable workload) of the agent. It is contemplated that other criteria can be developed depending on the organization and products and services of the organization.

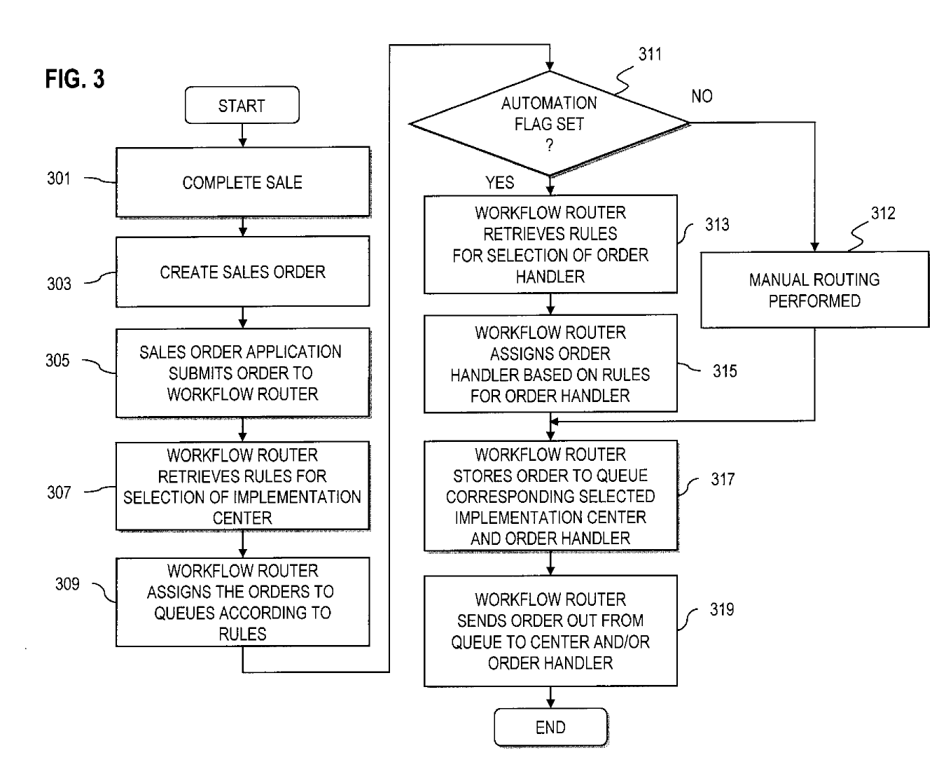

Under this rules-based process, order creators within the sales centers 209 are not burdened by having to determine the many parameters that need to be considered to assign the sales order to the appropriate implementation center 119. Consequently, the agent can focus on generating sales without having to expend time and effort to learning the many aspects of implementation. The process of routing sales orders are detailed in FIG. 3, as next explained.

FIG. 3 is a flowchart of an automated order process utilizing rules for routing sales orders, according to an exemplary embodiment. The automated order process can be organized into two stages or phases of automation. The first stage involves selection of an implementation center 119, while the second stage is optional and provides for the selection of a particular agent or order handler. In steps 301 and 303, an order creator completes a sale and subsequently captures the sales information in a sales order. Upon creation of the sales order, the sales order application 103 stores the relevant information in the transaction database 115, and the sales order is submitted to the workflow router 101, per step 305.

Next, in step 307, the workflow router 307 retrieves the rules for selection of the implementation center 119. For example, implementation center 119a may only be capable of handling orders for products A, B and C. Further, even if the order is for product A, implementation center 119a may be associated with a queue 207 that is full or otherwise unavailable. The rules specify how to handle such a scenario, by defaulting to a predetermined queue 207 or by selecting the shortest queue 207, for example. The workflow router 307, as in step 309, selects an appropriate implementation center 119 and assigns the orders to the corresponding queues 207 according to the retrieved rules. Alternatively, the selection logic 203 may postpone implementation center selection and proceed to examine all order handlers at the other implementation centers 119b and 119n.

Steps 301-309, according to an exemplary embodiment, constitute a first automation phase. To proceed to the next stage, the process utilizes an indicator, such as a flag, that the selection logic 203 examines to determine whether the next stage of automation can be performed. As such, the selection logic 203 checks the setting of an automation flag, per step 311, and can monitor the queues 207 for assignment to an order handler 211, on a periodic basis.

If no automation is specified, manual routing is performed, per step 312. However, if the flag indicates that automation should proceed, the workflow router 101 retrieves rules for selection of the order handler from the rules database 205 (step 313). According to one exemplary embodiment, the rules database 205 includes information about each order handler's current status (available or not), queues handled, products or services handled, tariffs (or regions) handled, maximum workload, and work hours (e.g., a combination of queue depth and work hours may indicate an order handler about to become available or about to become unavailable). Using this information, the selection logic 203 selects, for example, an order handler 211 to implement the order, per step 315. As the queues 207 are mapped, in one embodiment, to the order handlers 211, the workflow router 307 stores the sales order in the queue 207 assigned to the selected order handler 211, per step 317.

In step 319, the workflow router 101 sends the stored order from the assigned queue to the mapped implementation center 119 and the order handler 211.

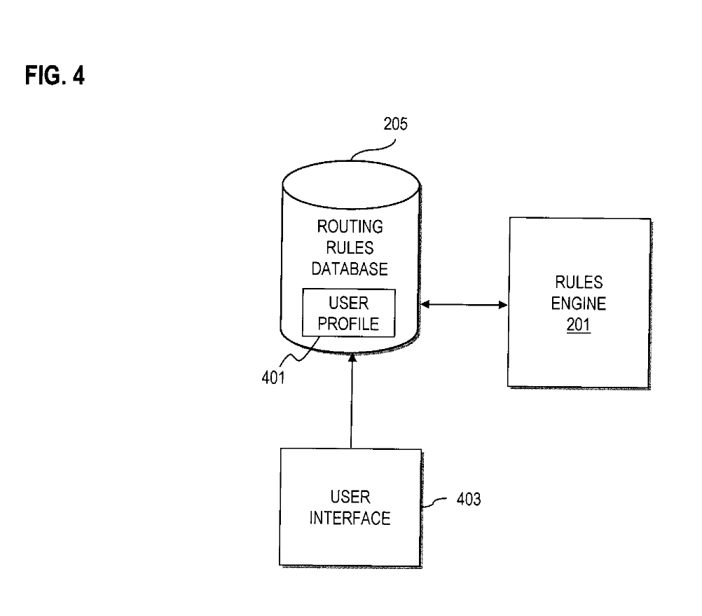

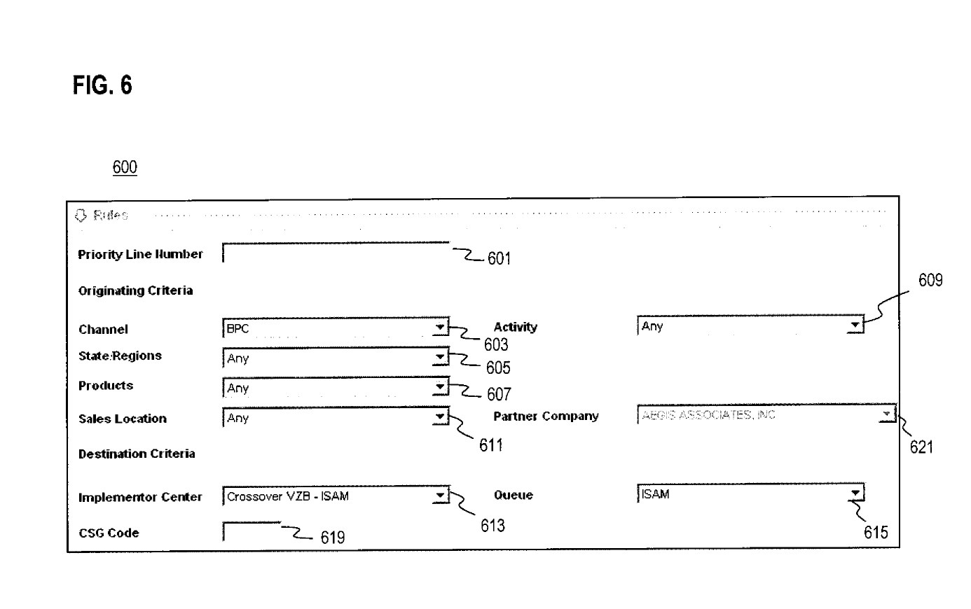

FIG. 4 is a diagram of routing rules database, according to an exemplary embodiment. As mentioned, a user profile 401 can be maintained to capture the rules particular to a certain user. Under this scenario, the user profile 401 resides within the routing rules database 205. The user profile 401 can be initialized and subsequently modified by a user, such as a system administrator, via a user interface 403. The user interface 403 permits the user (e.g., administrator) to manage, create and delete the rules to govern the routing by the workflow router 101. These rules can be saved in the database 205 in real time. Moreover, the rules can be added or modified on the fly. The user interface 403 can be a graphical user interface (GUI) such as a web-browser, or a standalone program. FIGS. 6-9 provide some exemplary screens relating to designating the rules for application by the workflow router 101.

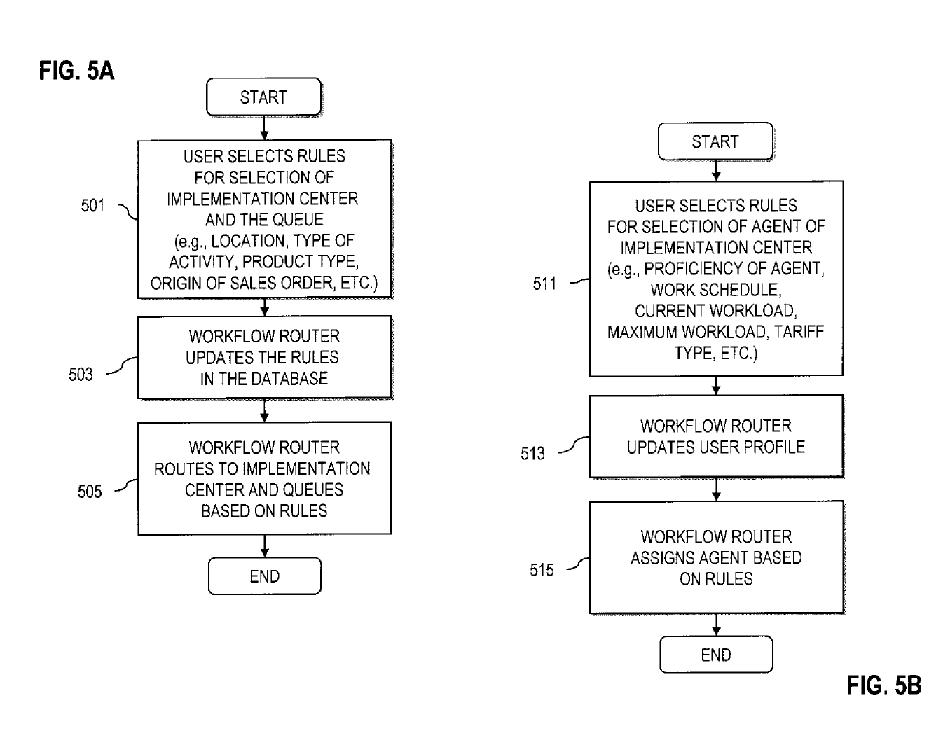

FIGS. 5A and 5B are flowcharts of processes of specifying the rules for selection of an implementation center and an order handler, respectively, according to various exemplary embodiments. These processes, by way of example, are explained with respect to the GUI of FIGS. 6-9. As seen in FIG. 5A, a user selects, as in step 501, rules for selection of an implementation center 119, using the screen 600 of FIG. 6. This screen 600 permits the user to specify the rules used to map an implementation center 119 to a queue 207. Field 601 provides for setting the priority of the sales order. The screen 600 also includes a field 603 for the sales channel (or origin of the sales order), a field 605 for a customer region, a field 607 for the product (or service ordered), a field 609 for the activity required, and field 611 to specify the sales location. Further, the user can indicate the implementation 119 using the field 613. Field 615 provides for the particular queue 207 that corresponds to the respective implementation center 119. Additionally, a field 617 can specify the CSG code, and field 619 provides an ability to select a partner organization.

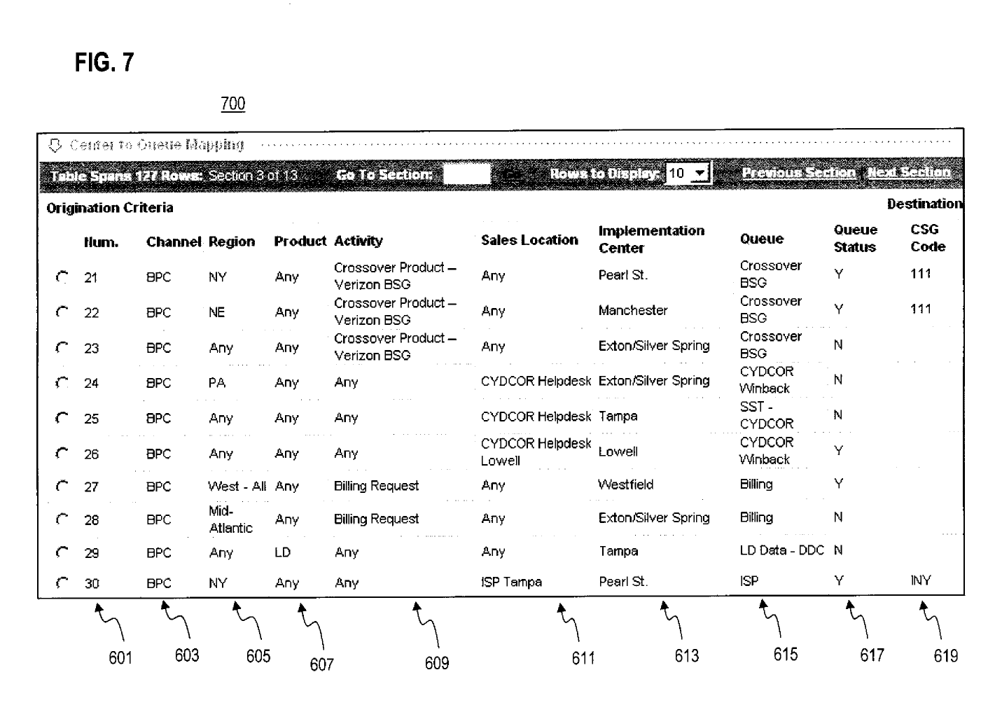

FIG. 7 represents a screen 700 that reflects all the rules that have been set by the user. As such, the following information is presented: a number field 701 that uniquely identifies a set of origination criteria; a channel field 703 for the sales channel; a region field 705; a product field 707, an activity field 709; a sales location field 711; an implementation center field 713; and a queue field 715. In this screen 700, a field 717 is provided for the status of the particular queue 207. Further, a CSG code field 719 is displayed.

Continuing with the example of FIG. 5A, the workflow router 101 updates the rules in the database 205, as in step 503, according to the designated rules. Next, in step 505, the workflow router 101 to routes sales order to an implementation center 119a-119n and associated queues 207 based on the rules.

A similar rules-based process is performed for specifying the rules for selection of the order handler 211, as illustrated in FIG. 5B. In step 511, the user selects rules for selection of an agent 211 within an implementation center 119. As previously described, according to one exemplary embodiment, the rules or criteria can include proficiency of the agent 211 on a particular product or service, work schedule of the agent 211, current workload of the agent 211, maximum workload of the agent 211, or tariff type handled by the agent 211. The workflow router 101 can update the user profile 401 to capture these rules, per step 513. Thereafter, the workflow router 101 can assign an agent 211 based on the specified rules (step 515).

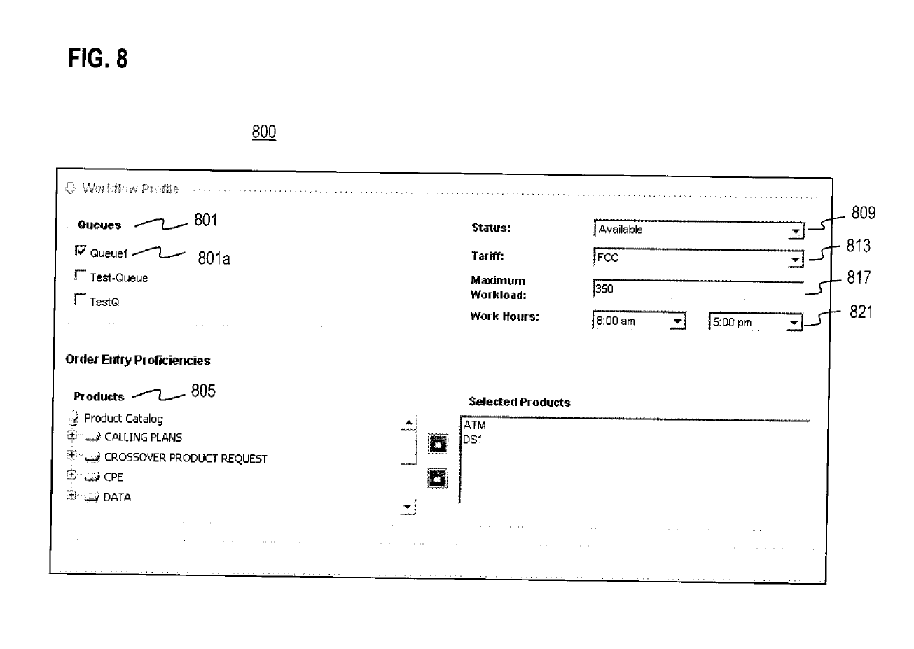

To obtain information about the agent 211, the system 100 provides a GUI (as shown in FIG. 8) for the agents 207 themselves to set values for proficiency, availability, work schedule, etc. As shown, an entry screen 800 includes a queue section 801 to permit the user to select which queues 207 the user is responsible for. Additionally, a products section 803 is provided to assist the user in selecting products and services contained in the folder icons. Upon selection of these products and services, these items are displayed in a selected products section 805. The screen 800 also provides a text box 807 for indication of the status of the agent 211—i.e., whether the agent 211 is available or unavailable. This value can be modified dynamically, in real-time.

A tariff text box 809 permits the agent 211 to select the particular tariffs handled by the agent 211. In addition, a text box 911 is provided to indicate the maximum workload of the agent 211. The value of maximum workload may be compared to a current workload of a particular agent 211 and thereby indicate the upcoming availability or non-availability of the agent 211. Furthermore, the agent 211 can input a work schedule using text box 813.

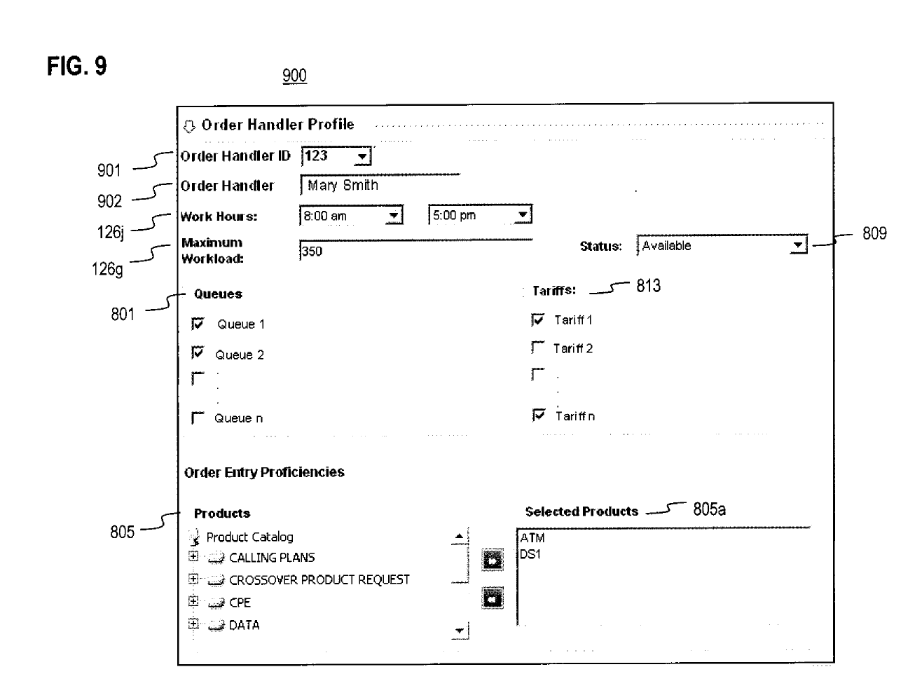

A user different from the agents themselves can specify the characteristics of the agent. For example, a system administrator can input the order handler's information using the input screen 900 of FIG. 9. In this example, the additional fields over that of FIG. 8 include an order handler identification (ID) box 901 and a box 903 for the name of the order handler. Sections 905-917 resemble the corresponding sections 801-813 of the screen 800. It is noted that in this screen 900, the tariffs section 913 is in form of check boxes that the user can select the applicable tariffs. It is contemplated that any of the sections 901-917 can be represented in a variety of forms to permit input by the user of the rules and criteria.

The administrator can initiate update of the rules by entering the order handler identifier in box 901. If the identifier does not exist, a new record may be created, and the administrator can complete the information through selecting values for the remaining fields or elements. If the identifier exists, the then-current element values are displayed and are available for modification.

Any number of data record maintenance implementations are available for this interface as well as the other GUIs of FIGS. 6-8. According to one exemplary embodiment, as shown in FIG. 9, selection is typically made via drop-down option presentation or selection from a frame comprising a limited set of options for a specific data element. Also, the options can be pre-populated. It is noted that the screens 600-900 are exemplary in nature and can be developed in a variety of formats depending on the applications and requirements of the user.

The above described processes relating to access control may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

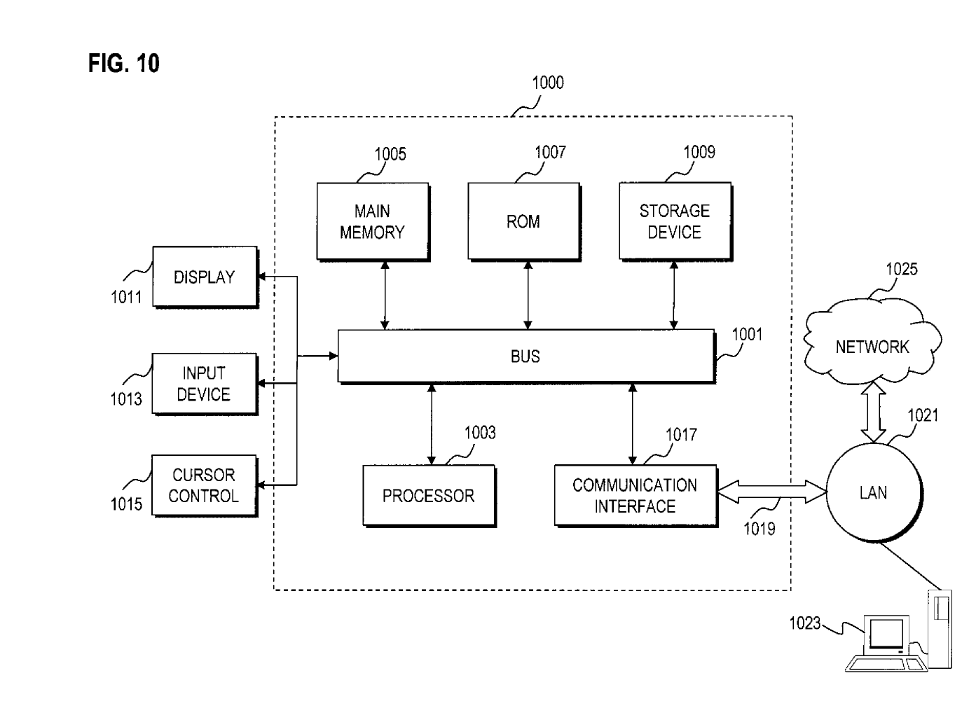

FIG. 10 illustrates a computer system 1000 upon which an exemplary embodiment can be implemented. For example, the processes described herein can be implemented using the computer system 1000. The computer system 1000 includes a bus 1001 or other communication mechanism for communicating information and a processor 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to an exemplary embodiment the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multiprocessing arrangement may also be employed to execute the instructions contained in main memory 1005. In alternative embodiments, hard-wired circuitry may be used in place of or in combination with software instructions to implement the exemplary embodiment. Thus, exemplary embodiments are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an exemplary embodiment through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of various embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
receiving a sales order; and
selecting one of a plurality of implementation centers for fulfilling a sales order based on a rule, wherein the sales order is stored in one of a plurality of queues that are mapped to the implementation centers.

2. A method according to claim 1, further comprising:
selecting, according to another rule, an agent among a plurality of agents for handling the sales order.

3. A method according to claim 2, wherein the other rule specifies criteria that include proficiency of the agent on a particular product or service, work schedule of the agent, current workload of the agent, maximum workload of the agent, or tariff type handled by the agent.

4. A method according to claim 2, wherein the one queue is further mapped to the selected agent.

5. A method according to claim 4, further comprising:
determining whether an automation flag is set, wherein the selection of the agent is performed if the automation flag is set.

6. A method according to claim 1, further comprising:
forwarding the sales order to a terminal of the selected agent.

7. A method according to claim 1, wherein the rule specifies criteria that includes implementation center location, type of activity associated with the sales order, product type, service type or sales center location.

8. A method according to claim 7, wherein the criteria are specified by a user via a graphical user interface (GUI).

9. An apparatus comprising:
a plurality of queues configured to store sales orders; and
selection logic configured to select one of a plurality of implementation centers for fulfilling a sales order based on a rule, wherein the sales order is stored in one of a plurality of queues that are mapped to the implementation centers.

10. An apparatus according to claim 9, further comprising:
logic configured to select, according to another rule, an agent among a plurality of agents for handling the sales order.

11. An apparatus according to claim 10, wherein the other rule specifies criteria that include proficiency of the agent on a particular product or service, work schedule of the agent, current workload of the agent, maximum workload of the agent, or tariff type handled by the agent.

12. An apparatus according to claim 10, wherein the one queue is further mapped to the selected agent.

13. An apparatus according to claim 12, wherein the selection logic is further configured to determine whether an automation flag is set, wherein the selection of the agent is performed if the automation flag is set.

14. An apparatus according to claim 9, wherein the received the sales order is forwarded to a terminal of the selected agent.

15. An apparatus according to claim 9, wherein the rule specifies criteria that include implementation center location, type of activity associated with the sales order, product type, service type or sales center location.

16. An apparatus according to claim 15, wherein the criteria are specified by a user via a graphical user interface (GUI).

17. A system comprising:
a database configured to store a plurality of rules for routing sales orders; and
a workflow router configured to receive a sales order, and to select one of a plurality of implementation centers for fulfilling a sales order based on one of the rules, wherein the workflow router includes a plurality of queues that are mapped to implementation centers for processing the sales orders.

18. A system according to claim 17, wherein the workflow router is further configured to select, according to a second rule, an agent among a plurality of agents for handling the sales order.

19. A system according to claim 18, wherein the second rule specifies criteria that include proficiency of the agent on a particular product or service, work schedule of the agent, current workload of the agent, maximum workload of the agent, or tariff type handled by the agent.

20. A system according to claim 18, wherein the one queue is further mapped to the selected agent.

21. A system according to claim 20, wherein the workflow router is further configured to determine whether an automation flag is set, wherein the selection of the agent is performed if the automation flag is set.

22. A system according to claim 17, wherein the workflow router is further configured to forward the sales order to a terminal of the selected agent.

23. A system according to claim 17, wherein the first rule specifies criteria that include implementation center location, type of activity associated with the sales order, product type, service type or sales center location.

24. A system according to claim 23, wherein the criteria are specified by a user via a graphical user interface (GUI).
